(19) United States
(12) Patent Application Publication
(10) Pub. No.: US 2026/0175634 A1
(43) Pub. Date: Jun. 25, 2026

(54) Amphibious Front Suspension System

(71) Applicants: Zhuhai College of Science and Technology, Zhuhai City (CN); Shenzhen HiSibi Marine Technology Company Limited, Shenzhen City (CN)

(72) Inventors: Mengqi Deng, Zhuhai City (CN); Baoqing Deng, Zhuhai City (CN); Zhuo Yang, Zhuhai City (CN); Jun Shi, Shenzhen City (CN); Linghui Zeng, Shenzhen City (CN); Jiayuan Yuan, Zhuhai City (CN); Jinming Liang, Zhuhai City (CN); Yongzhe Zhang, Zhuhai City (CN)

(21) Appl. No.: 19/416,506

(22) Filed: Dec. 11, 2025

(30) Foreign Application Priority Data
Dec. 23, 2024 (CN) 202411899802.0

(51) Int. Cl. B60F 3/00; B60B 35/12; B60G 13/00

(52) U.S. Cl. CPC B60F 3/003; B60B 35/122; B60B 35/127; B60G 13/005

(57) ABSTRACT

The amphibious front suspension system includes a mounting seat. A drive axle assembly is fixedly mounted in the mounting seat. Both sides of the top of the mounting seat are in hinged connection with hydraulic cylinders. A first connecting block and a second connecting block are respectively fixedly connected to each side of the mounting seat in a vertical direction. Supporting arms are respectively connected to sides that are of the two first connecting blocks and that are away from each other through pin shafts. Ends, away from the mounting seat, of the supporting arms are respectively in hinged connection with movable ends of the hydraulic cylinders. Upper fork arms and lower fork arms are connected to sides that are of two second connecting blocks and that are away from each other through pin shafts. Lateral mounting frames are symmetrically arranged on both sides of the mounting seat.

### CROSS-REFERENCE TO RELATED APPLICATION

This patent application claims the benefit and priority of Chinese Patent Application No. 202411899802.0 filed with the China National Intellectual Property Administration on Dec. 23, 2024, the disclosure of which is incorporated by reference herein in its entirety as part of the present application.

### TECHNICAL FIELD

The present disclosure relates to the field of amphibious vehicles, in particular to an amphibious front suspension system.

### BACKGROUND

When an amphibious vehicle works, engine power is distributed through a transfer case for power distribution, so that power is available on the water, power is available on the land, and two powers work simultaneously. When power is switched, synchronous automatic switching control is synchronously implemented for onshore structures, a wheel state, a suspension state, gear information, a track state, and an intercooling state; and synchronous automatic switching control is also implemented for water mechanisms, a head wing plate, a tail wing plate, a drainage mechanism, a lifesaving mechanism, and the like.

However, an existing front suspension of the amphibious vehicle is complex in structure, and inconvenient for maintenance. In addition, large volume of the front suspension makes it inconvenient to retract the tires when traveling on the water and on the land, and the structure is poor in stability and anti-interference capability.

### SUMMARY

An objective of the present disclosure is to provide an amphibious front suspension system, so as to solve the problems mentioned in the background art.

To achieve the foregoing objective, the present disclosure provides the following technical solution. An amphibious front suspension system includes a mounting seat, where a drive axle assembly is fixedly mounted in the mounting seat, two sides of a top of the mounting seat are in hinged connection with hydraulic cylinders, each of two first connecting blocks and each of two second connecting blocks are fixedly connected to a corresponding one of two sides of the mounting seat in a vertical direction, supporting arms are respectively connected to sides that are of the two first connecting blocks and that are away from each other through first pin shafts, ends, away from the mounting seat, of the supporting arms are respectively in hinged connection with movable ends of the hydraulic cylinders, upper fork arms and lower fork arms are connected to sides that are of the two second connecting blocks and that are away from each other through second pin shafts, lateral mounting frames are symmetrically arranged on the two sides of the mounting seat, each of the upper fork arms and each of the lower fork arms are respectively fixedly connected to a top and a bottom of a corresponding one of the lateral mounting frames through bolts, ends of ones of cage universal joints are fixedly mounted at central positions of the lateral mounting frames, ends of the drive axle assembly are fixedly connected to ends of other ones of the cage universal joints, a side of each of the ones of the cage universal joints and a side of each of the other ones of the cage universal joints that are adjacent to each other are fixedly connected through a half shaft, a tire is arranged on a side of the each of the lateral mounting frames, and a transmission shaft of the tire is fixedly connected to an other end of each of the ones of the cage universal joints fixedly mounted at the central positions of the lateral mounting frames.

In some embodiments, shock absorbers are symmetrically arranged on the two sides of the mounting seat, a top of each of the shock absorbers is hinged to a bottom of a side, away from the mounting seat, of a corresponding one of the supporting arms, and a bottom of each of the shock absorbers is hinged to a top of a side, away from the mounting seat, of the upper fork arm.

In some embodiments, the drive axle assembly includes a drive axle housing fixedly mounted at a central position of the mounting seat, and a transmission main shaft is rotatably connected into the drive axle housing through a bearing.

In some embodiments, a driving bevel gear is fixedly connected to an end of the transmission main shaft, and driven bevel gears mutually meshed with the driving bevel gear are respectively rotatably connected to two sides of an interior of the drive axle housing.

In some embodiments, a central position of each of the driven bevel gears is fixedly sleeved on an outer side of a lateral transmission shaft, the lateral transmission shaft rotatably runs through two sides of the drive axle housing as well as the two sides of the mounting seat and is fixedly connected to the ends of the other ones of the cage universal joints adjacent to the mounting seat.

In some embodiments, one of the upper fork arms and one of the lower fork arms are arranged on each of the two sides of the mounting seat, and the one of the upper fork arms and the one of the lower fork arms are both symmetrically distributed on two sides of the half shaft relative to the half shaft.

In some embodiments, the one of the upper fork arms and the one of the lower fork arms that are both distributed on the two sides of the half shaft are connected to a corresponding one of the two second connecting blocks through third pin shafts.

Compared with the prior art, the system achieves the following beneficial effects.

In the structure of the present disclosure, structures on both sides of the mounting seat need to be retracted. When traveling on the water, each hydraulic cylinder is controlled so that the movable end of each hydraulic cylinder drives an end of the supporting arm to move. The supporting arm is hinged to the first connecting block, and both ends of the shock absorber are respectively hinged to the supporting arm and the upper fork arm. Therefore, driven by the shock absorbers, the upper fork arms and the lower fork arms on both sides of the mounting seat are respectively retracted upward along pin shaft joints of the second connecting blocks. The upper fork arm and the lower fork arm in each group share one pin shaft for rotation, thereby simplifying a mounting and design process of the suspension system, reducing the quantity and complexity of components, and also reducing manufacturing and assembling difficulty. In addition, through arrangement and layout of an entire structure, space occupied by the suspension system is smaller, and space design of a chassis is optimized, and more space is retained for other key components such as a power system and a transmission mechanism. The upper fork arm and the lower fork arm are symmetrically distributed along two sides of the cage universal joint adjacent to the mounting seat, so that rotation axes of the upper fork arm and the lower fork arm in a retracting process are consistent with an axis of the cage universal joint adjacent to the mounting seat. The impacts of movement of the suspension system on a power transmission path is significantly reduced. The system can maintain a relatively stable input end of the cage universal joint, thereby avoiding impacts of an excessive angle or a rapid change on transmission efficiency. The system is particularly applicable to amphibious vehicles, and can ensure continuity and stability of power transmission during jolting or steering. Moreover, the upper fork arm and the lower fork arm rotate around a same pin shaft axis, which helps reduce a lateral force or an excess torque that is brought in an up-and-down motion process of the tires, thereby optimizing grounding performance of the tires and improving overall stability of the suspension system.

### BRIEF DESCRIPTION OF THE DRAWINGS

FIG. 1 is a structural schematic diagram according to an embodiment of the present disclosure.

FIG. 2 is a structural side view according to an embodiment of the present disclosure.

FIG. 3 is a structural top view according to an embodiment of the present disclosure.

FIG. 4 is a three-dimensional structural schematic diagram according to an embodiment of the present disclosure.

Reference numerals: 1 mounting seat; 2 drive axle assembly; 3 hydraulic cylinder; 4 first connecting block; 5 second connecting block; 6 supporting arm; 7 upper fork arm; 8 lower fork arm; 9 cage universal joint; 10 half shaft; 11 lateral mounting frame; 12 transmission shaft; 13 tire; 14 steering gear; 15 shock absorber; 21 drive axle housing; 22 transmission main shaft; 23 driving bevel gear; 24 driven bevel gear; and 25 lateral transmission shaft.

### DETAILED DESCRIPTION OF THE EMBODIMENTS

The following clearly and completely describes technical solutions in embodiments of the present disclosure with reference to drawings in the embodiments of the present disclosure. Apparently, the described embodiments are merely a part rather than all of the embodiments of the present disclosure. All other embodiments obtained by those skilled in the art on the basis of the embodiments of the present disclosure without requiring the exercise of inventive effort fall within the scope of protection of the present disclosure.

### Embodiments

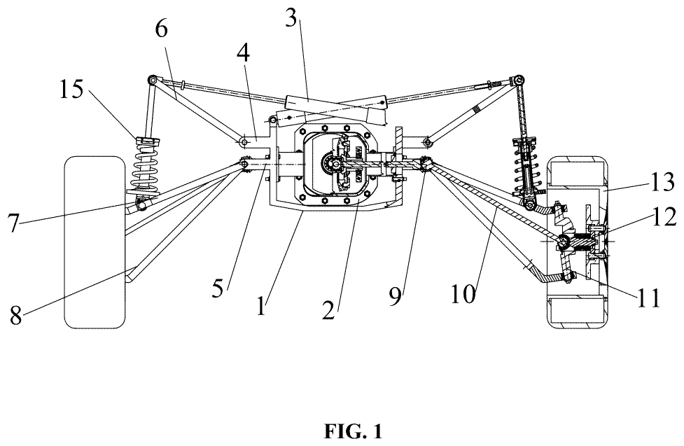

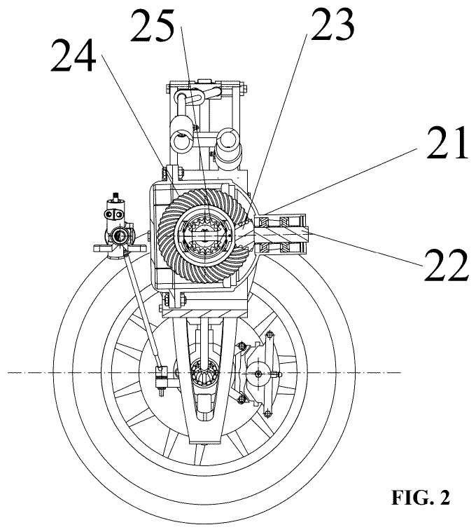

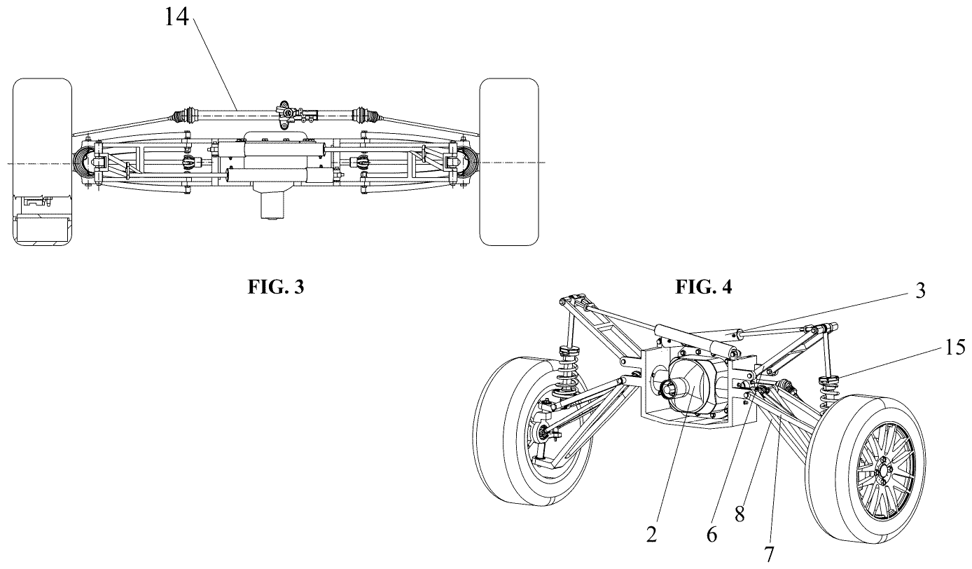

Referring to FIG. 1 to FIG. 4, an amphibious front suspension system shown in drawings includes a mounting seat 1. A drive axle assembly 2 is fixedly mounted in the mounting seat 1, and both sides of the top of the mounting seat 1 are in hinged connection with hydraulic cylinders 3. A first connecting block 4 and a second connecting block 5 are respectively fixedly connected to each side of the mounting seat 1 in a vertical direction. Supporting arms 6 are respectively connected to sides that are of the two first connecting blocks 4 and that are away from each other through pin shafts. Ends, away from the mounting seat 1, of the supporting arms 6 are respectively in hinged connection with movable ends of the hydraulic cylinders 3. Upper fork arms 7 and lower fork arms 8 are connected to sides that are of the two second connecting blocks 5 and that are away from each other through pin shafts, and lateral mounting frames 11 are symmetrically arranged on both sides of the mounting seat 1. Each of the upper fork arms 7 and each of the lower fork arms 8 are respectively fixedly connected to the top and the bottom of the lateral mounting frame 11 through bolts. A cage universal joint 9 is fixedly mounted at a central position of the lateral mounting frame 11. An end of the drive axle assembly 2 is fixedly connected to an end of the other cage universal joint 9, and sides that are of the two cage universal joints 9 and that are adjacent to each other are fixedly connected by using a half shaft 10. A tire 13 is arranged on a side of the lateral mounting frame 11, and a transmission shaft 12 of the tire 13 is fixedly connected to the other end of the cage universal joint 9 fixedly mounted at the central position of the lateral mounting frame 11.

In this embodiment, shock absorbers 15 are symmetrically arranged on both sides of the mounting seat 1, and the top of each shock absorber 15 is hinged to the bottom of a side that is of the corresponding supporting arm 6 and that is away from the mounting seat 1. The bottom of each shock absorber 15 is hinged to the top of a side that is of the upper fork arm 7 and that is away from the mounting seat 1. The drive axle assembly 2 includes a drive axle housing 21 fixedly mounted at a central position of the mounting seat 1, and a transmission main shaft 22 is rotatably connected into the drive axle housing 21 through a bearing. A driving bevel gear 23 is fixedly connected to an end of the transmission main shaft 22, and driven bevel gears 24 mutually meshed with the driving bevel gear 23 are respectively rotatably connected to both sides of the interior of the drive axle housing 21. A central position of each of the driven bevel gears 24 is fixedly sleeved on an outer side of the lateral transmission shaft 25, and the lateral transmission shaft 25 rotatably runs through both sides of the drive axle housing 21 and both sides of the mounting seat 1 and is fixedly connected to the ends of the cage universal joints 9 adjacent to the mounting seat 1. A upper fork arm 7 and a lower fork arm 8 are arranged on each side of the mounting seat 1, and the upper fork arm 7 and the lower fork arm 8 are both symmetrically distributed on both sides of the half shaft 10 relative to the half shaft 10. The upper fork arm 7 and the lower fork arm 8 that are both distributed on both sides of the half shaft 10 are connected to the corresponding second connecting block 5 through pin shafts.

Further, a steering gear 14 for steering is further arranged on one side of the mounting seat 1, where the steering gear 14 is a technology fully disclosed in the prior art, and details are not described herein again. In addition, a planetary gear and a half shaft gear that are meshed with each other are further arranged in the drive axle assembly 2, so as to implement a differential driving process of two tires 13 in a steering process. This is fully disclosed in the prior art, and details are not described herein again.

Further, the transmission main shaft 22 is fixedly connected to an engine power output end, so that the two lateral transmission shafts 25 are respectively driven to rotate by using transmission of the transmission main shaft 22 and meshed transmission of the driving bevel gear 23 and the two driven bevel gears 24. Then, the lateral transmission shafts 25 are connected to the cage universal joints 9, and each transmission shaft 12 is driven to rotate through transmission of the two cage universal joints 9 and the half shaft 10, so as to implement rotation of the two tires 13 and driving on the land. The shock absorbers 15 arranged on both sides of the mounting seat 1 are configured to perform shock absorption in a traveling process.

Further, structures on both sides of the mounting seat 1 need to be retracted. When traveling on the water, each hydraulic cylinder 3 is controlled so that the movable end of each hydraulic cylinder 3 drives an end of the supporting arm 6 to move. The supporting arm 6 is hinged to the first connecting block 4, and both ends of the shock absorber 15 are respectively hinged to the supporting arm 6 and the upper fork arm 7. Therefore, driven by the shock absorbers 15, the upper fork arms 7 and the lower fork arms 8 on both sides of the mounting seat 1 are respectively retracted upward along pin shaft joints of the second connecting blocks 5. The upper fork arm 7 and the lower fork arm 8 in each group share one pin shaft for rotation, thereby simplifying a mounting and design process of the suspension system, reducing the quantity and complexity of components, and also reducing manufacturing and assembling difficulty. In addition, through arrangement and layout of an entire structure, space occupied by the suspension system is smaller, and space design of a chassis is optimized, and more space is retained for other key components such as a power system and a transmission mechanism. The upper fork arm 7 and the lower fork arm 8 are symmetrically distributed along two sides of the cage universal joint 9 adjacent to the mounting seat 1, so that rotation axes of the upper fork arm 7 and the lower fork arm 8 in a retracting process are consistent with an axis of the cage universal joint 9 adjacent to the mounting seat 1. The impacts of movement of the suspension system on a power transmission path is significantly reduced. The system can maintain a relatively stable input end of the cage universal joint 9, thereby avoiding impacts of an excessive angle or a rapid change on transmission efficiency. The system is particularly applicable to amphibious vehicles, and can ensure continuity and stability of power transmission during jolting or steering. Moreover, the upper fork arm 7 and the lower fork arm 8 rotate around a same pin shaft axis, which helps reduce a lateral force or an excess torque that is brought in an up-and-down motion process of the tires 13, thereby optimizing grounding performance of the tires 13 and improving overall stability of the suspension system.

It needs to be noted that in this specification, relational terms such as “first” and “second” are only used to distinguish one entity or operation from another, and do not necessarily require or imply that any actual relationship or sequence exists between these entities or operations. Moreover, the terms “comprise”, “include”, or any other variants are intended to cover a non-exclusive inclusion, so that a process, a method, an article, or a device that includes a list of elements not only includes those elements but also includes other elements that are not expressly listed, or further includes elements inherent to such a process, method, article, or device.

Although the embodiments of the present disclosure have already been illustrated and described, various changes, modifications, replacements and variants can be made by those skilled in the art without departing from the principle and the spirit of the present disclosure, and thus the scope of the present disclosure should be restricted by claims and equivalents thereof.

What is claimed is:

1. An amphibious front suspension system, comprising a mounting seat (1), wherein
a drive axle assembly (2) is fixedly mounted in the mounting seat (1), two sides of a top of the mounting seat (1) are in hinged connection with hydraulic cylinders (3), each of two first connecting blocks (4) and each of two second connecting blocks (5) are fixedly connected to a corresponding one of two sides of the mounting seat (1) in a vertical direction, supporting arms (6) are respectively connected to sides that are of the two first connecting blocks (4) and that are away from each other through first pin shafts, ends, away from the mounting seat (1), of the supporting arms (6) are respectively in hinged connection with movable ends of the hydraulic cylinders (3), upper fork arms (7) and lower fork arms (8) are connected to sides that are of the two second connecting blocks (5) and that are away from each other through second pin shafts, lateral mounting frames (11) are symmetrically arranged on the two sides of the mounting seat (1), each of the upper fork arms (7) and each of the lower fork arms (8) are respectively fixedly connected to a top and a bottom of a corresponding one of the lateral mounting frames (11) through bolts, ends of ones of cage universal joints (9) are fixedly mounted at central positions of the lateral mounting frames (11), ends of the drive axle assembly (2) are fixedly connected to ends of other ones of the cage universal joints (9), a side of each of the ones of the cage universal joints (9) and a side of each of the other ones of the cage universal joints (9) that are adjacent to each other are fixedly connected through a half shaft (10), a tire (13) is arranged on a side of the each of the lateral mounting frames (11), and a transmission shaft (12) of the tire (13) is fixedly connected to an other end of each of the ones of the cage universal joints (9) fixedly mounted at the central positions of the lateral mounting frames (11).

2. The amphibious front suspension system according to claim 1, wherein shock absorbers (15) are symmetrically arranged on the two sides of the mounting seat (1), a top of each of the shock absorbers (15) is hinged to a bottom of a side, away from the mounting seat (1), of a corresponding one of the supporting arms (6), and a bottom of each of the shock absorbers (15) is hinged to a top of a side, away from the mounting seat (1), of the upper fork arm (7).

3. The amphibious front suspension system according to claim 2, wherein the drive axle assembly (2) comprises a drive axle housing (21) fixedly mounted at a central position of the mounting seat (1), and a transmission main shaft (22) is rotatably connected into the drive axle housing (21) through a bearing.

4. The amphibious front suspension system according to claim 3, wherein a driving bevel gear (23) is fixedly connected to an end of the transmission main shaft (22), and driven bevel gears (24) mutually meshed with the driving bevel gear (23) are respectively rotatably connected to two sides of an interior of the drive axle housing (21).

5. The amphibious front suspension system according to claim 4, wherein a central position of each of the driven bevel gears (24) is fixedly sleeved on an outer side of a lateral transmission shaft (25), the lateral transmission shaft (25) rotatably runs through two sides of the drive axle housing (21) as well as the two sides of the mounting seat (1) and is fixedly connected to the ends of the other ones of the cage universal joints (9) adjacent to the mounting seat (1).

6. The amphibious front suspension system according to claim 5, wherein one of the upper fork arms (7) and one of the lower fork arms (8) are arranged on each of the two sides of the mounting seat (1), and the one of the upper fork arms (7) and the one of the lower fork arms (8) are both symmetrically distributed on two sides of the half shaft (10) relative to the half shaft (10).

7. The amphibious front suspension system according to claim 6, wherein the one of the upper fork arms (7) and the one of the lower fork arms (8) that are both distributed on the two sides of the half shaft (10) are connected to a corresponding one of the two second connecting blocks (5) through third pin shafts.
